(19) United States
(12) Patent Application Publication
(10) Pub. No.: US 2006/0121342 A1
(43) Pub. Date: Jun. 8, 2006

(54) Secondary battery and production method thereof

(75) Inventors: Yuichiro Sano, Hitachinaka (JP); Toru Miyasaka, Hitachinaka (JP); Shin Nishimura, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/274,502

(22) Filed: Nov. 16, 2005

(30) Foreign Application Priority Data
Nov. 17, 2004 (JP) 2004-332585

(51) Int. Cl. H01M 10/04; H01M 4/66

(52) U.S. Cl. 429/162; 429/128; 429/245; 29/623.3; 29/623.5

(57) ABSTRACT

The present invention proposes a secondary battery structure with a solid electrolyte, which can secure high reliability at a low cost and realize high energy density and high output, and also proposes a method for producing the secondary battery structure simply at a low cost while realizing reduced size and weight. The present invention provides a secondary battery structure of planar, inter digital shape as the one with a solid electrolyte, capable of realizing reduced cost, high safety, high energy density and high output, wherein anode and cathode collectors of pectinate shape are provided to face each other on a flat substrate by patterning, anode and cathode material particles are patterned on the respective anode and cathode collectors by electrophotography in the vertical direction to the collector surface to form the vertical electrodes, and the gap between the adjacent anode and cathode is filled with the solid electrolyte.

### BACKGROUND OF THE INVENTION

The present invention relates to a secondary battery which uses a solid electrolyte, and a production method thereof.

Electrolytic solutions for secondary batteries have been generally non-aqueous. More recently, a number of solid electrolyte type batteries which use no electrolytic solution have been proposed (as disclosed by, e.g., Patent Document 1). Dispensing with an electrolytic solution eliminates several disadvantages, e.g., risks caused by solution leakage or ignition, involved in conventional batteries with an impregnated organic electrolytic solution, to provide a safer battery. Moreover, it eliminates need of an expensive separator as an essential member of a conventional battery structure for holding an electrolytic solution or preventing a physical short-circuit between electrodes, thus reducing the battery cost.

Solid electrolyte type batteries, however, involve their own problems, e.g., lower ion conductivity of a solid electrolyte than that of an electrolytic solution, and increased resistance in the interface between the solid electrolyte and anode or cathode, all of which are solid, because these solids come into contact with each other in the interface partly at points, to limit migration of an ion-conducting substance in the interface.

In order to solve these problems, Patent Document 2 proposes a method which incorporates a specific alkali metal salt in, e.g., polyethylene oxide to improve ion conductivity. Patent Document 3 proposes a method which directly forms electrodes with a solid electrolyte of reduced thickness in-between.

(Patent Document 1) JP-A-07-326372

(Patent Document 2) JP-A-2002-158039

(Patent Document 3) JP-A-2004-185862

### BRIEF SUMMARY OF THE INVENTION

These conventional techniques, however, fail to achieve an ion conductivity which a secondary battery electrolyte is practically required to have (1 mS/cm or more at 25° C.).

It is an object of the present invention to provide a novel structure of solid electrolyte type secondary battery which can realize a high energy density and high output while keeping the cost at a low level and high reliability. It is another object to provide a method for producing the secondary battery structure simply at a low cost.

The present invention provides a solid electrolyte type secondary battery in the planar, and inter digital form having an anode collector and cathode collector in the inter digital form, facing each other on the same smooth and flat plane, for the anode (positive electrode) and cathode (negative electrode); anode and cathode each of particles patterned on the collector in the direction perpendicular to the collector surface by an electrophotographic process; and a gap filled with a solid electrolyte between the anode and cathode.

The present invention can provide a solid electrolyte type secondary battery of low cost, both in material and production, and high reliability coming from high safety, while keeping performance of practical level.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 outlines a structure of the secondary battery of the present invention.

FIG. 2 outlines a structure of conventional secondary battery.

FIG. 3 illustrates one example of patterning process for the secondary battery of the present invention.

FIG. 4 outlines an electrode material particle coated with a binder resin layer incorporated with an electroconductive material.

FIG. 5 outlines an electrode material particle, whose electrode particles are present not in the form of single nucleus but cluster.

FIG. 6 outlines an electrode material particle containing electroconductive material particles and electrode material particles, both incorporated in a binder resin.

FIG. 7 outlines an electrode material, whose electrode material particles themselves are clustered.

### DESCRIPTION OF REFERENCE NUMERALS

1: Cathode (negative electrode), 2: Anode (positive electrode), 3: Solid electrolyte, 4: Cathode collector, 5: Anode collector, 6: Substrate, 7: Separator (solid electrolyte), 8: Anode, 9: Cathode, 10: Anode collector, 11: Cathode collector, 12: Binder, 13: Electroconductive material, 14: Electrode material

### DETAILED DESCRIPTION OF THE INVENTION

The present invention is described in detail by EXAMPLE.

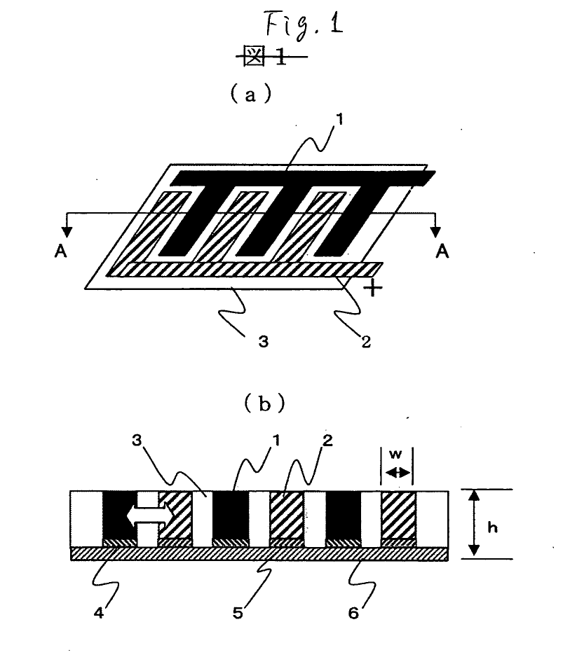

FIG. 1 illustrates the solid electrolyte type secondary battery in the inter digital form of the present invention, where FIG. 1(a) is a plan view and FIG. 1(b) is a cross-sectional view along the line A-A. As shown, the substrate 6 supports the anode 2 of an anode material and cathode 1 of a cathode material via the anode collector 5 and cathode collector 4, respectively, with the solid electrolyte 3 between these electrodes. The anode 2 and cathode 1 in the inter digital form faced each other with tines arranged at given intervals and in meshing engagement with each other, as illustrated in FIG. 1(a). The battery has vertically extended anode and cathode, and hence can have an increased aspect ratio (h/w). This structure brings effects of increasing output and reducing required material quantities. The battery of high voltage can be realized by stacking in layers the electrodes supported by the substrate, which is made of an insulating material.

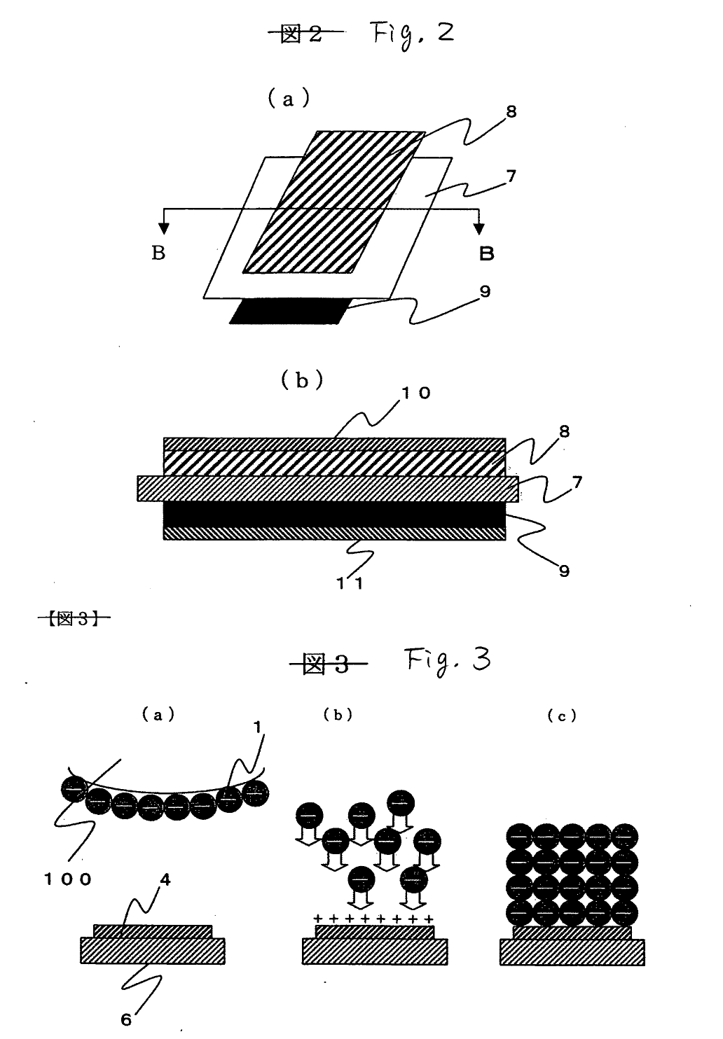

FIG. 2 illustrates a conventional, planar layer type secondary battery. As shown, the cathode material (cathode) 9 and anode material (anode) 8 are provided with the solid electrolyte or separator 8 placed in-between, and the cathode collector 11 and anode collector 10 are provided on the cathode and anode, respectively. This structure involves a problem that the cost increases when the interfacial area between the battery electrode and electrolyte is expanded.

The secondary battery structure of the present invention, illustrated in FIG. 1, can realize an expanded effective electrode area for the same volume or collector area. As a result, it can reduce internal resistance of the electrode while keeping a required energy density, and sufficiently work as a secondary battery even with a solid electrolyte, which has a lower ion conductivity than an electrolytic solution.

The secondary battery structure of the present invention can adopt a vertically extended electrode shape, which is stronger in the vertical direction than a planar layer type secondary battery. Therefore, it can sufficiently prevent a physical short circuit by the solid electrolyte alone, and secure reliability without a separator.

Assume that the anode collectors 5 and cathode collectors 4 are provided on the same smooth plane (substrate). These collectors 4 and 5 can be formed by various methods, e.g., ink-jet printing, lithography or nano-printing for producing a wiring pattern with droplets dispersed with metal particles as the collector material, or electrophotography by the aid of a laser printer for producing a wiring pattern with fine metal particles or a material containing these particles.

Any electroconductive material, e.g., metal, may be used as the electrode material so long as it is stable at a working potential of the secondary battery. The suitable metals include aluminum for the anode collector 5 and copper for the cathode collector 4. The patterned collector preferably has a smooth and flat surface.

The anode 2 for the present invention, which reversibly occludes and releases lithium, comprises an anode active material, e.g., lithium cobaltate (LiCoO₂), lithium nickelate (LiNiO₂), lithium manganate (LiMnO₂) of layered structure, layered compound, e.g., LiMnₓNi_{y}Co_{z}O₂ (where x+y+z=1, 0≦y<1, 0≦z<1 and 0≦x<1) as a composite oxide comprising a plurality of transition metal elements, a compound substituted with one or more transition metals, lithium manganate (Li₁₊ₓMn₂₋ₓO₄, where x=0 to 0.33), Li₁₊ₓMn_{2-x-y}MyO₄ (where M contains at least one species of metal selected from the group consisting of Ni, Co, Cr, Cu, Fe, Al and Mg, x=0 to 0.33, y=0 to 1.0 and 2−x−y>0), LiMnO₃, LiMn₂O₃, LiMnO₂, LiMn₂₋ₓMxO₂ (where M contains at least one species of metal selected from the group consisting of Co, Ni, Fe, Cr, Zn and Ta, and x=0.01 to 0.1), Li₂Mn₃MO₃ (where M contains at least one species of metal selected from the group consisting of Fe, Co, Ni, Cu and Zn), copper-lithium oxide (Li₂CuO₂), vanadium oxide (e.g., LiV₃O₃, LiFe₃O₄, V₂O or Cu₂V₂O₇), disulfide compound, or mixture containing Fe₂(MoO₄)₃ or the like, which is sluirried with a high-molecular-weight compound dissolved in a low-boiling-point solvent or by being mixed with a polymerizable compound. The anode 2 can be formed by coating the anode collector 5 in the form of metal foil, e.g., aluminum foil, with the slurry and pressing the resulting film to a given density.

The cathode 1, which reversibly occludes and releases lithium, comprises an easy-to-graphitize material, e.g., natural graphite, petroleum-based coke or coal pitch coke as a cathode active material, heat-treated at high temperature of 2500° C. or higher. These materials include mesophase carbon, amorphous carbon, fibrous carbon, a metal which can be alloyed with lithium and carbon particles coated with a metal. The cathode active material is sluirried with a high-molecular-weight compound dissolved in a low-boiling-point solvent or by being mixed with a polymerizable compound. The cathode 1 can be formed by coating the cathode collector in the form of metal foil, e.g., copper foil, with the slurry and pressing the resulting film to a given density. The other cathode active materials include a metal selected from the group consisting of lithium, aluminum, tin, silicon, indium, gallium and magnesium, alloy thereof, or metal oxide.

Each of the anode and cathode materials responsible for reversible occlusion and release by the ion conductor is composed of particles, when it is patterned on the collector surface by an electrophotographic process, where it is patterned in the direction perpendicular to the collector surface.

Electrophotography for electrode patterning may be carried out by a dry or wet process. FIG. 3 illustrates a dry process for cathode patterning by a laser printer working based on electrostatic development. As illustrated, the collector 4 positively (or negatively) charged on the substrate 6 is patterned by a Coulomb force with the cathode (or anode) material particles 1 negatively (or positively) charged by friction or the like. In other words, the electrode material, in place of a toner for electrophotography, is charged by friction in an electrode material container (not shown) and then deposited on the roll 100, which corresponds to a development roll in an electrophotographic device. The substrate 6 which supports the charged collector 4 is moved against the roll 100 which supports the electrode material 1. This allows the electrode material 1 to be transferred from the roll 100 surface towards the collector 4 as illustrated in FIG. 3(b), and deposited as illustrated in FIG. 3(c). In order to deposit the cathode material 1 composed of fine particles, the collector 4 should be charged fairly more strongly than the material 1 to prevent scattering of the particles by repulsion between them.

The wet process disperses an anode or cathode material beforehand in a solvent as a carrier, as in a laser printer for development with a solution, and charges the material particles in the solvent. A voltage is applied to between the roll and collector to be patterned, the former transferring the solvent dispersed with the electrode material particles for development. This transfers the electrode material particles dispersed in the solvent onto the collector by electrophoresis for patterning.

The dry process needs neither organic solvent, unlike a conventional electrode material coating process, nor drying step, and hence is advantageous viewed from simplified process and reduced cost and environmental loads.

The wet process disperses electrode material particles in a carrier solvent and can prevent scattering of the particles. Therefore, it can use micron-size or finer particles, and give finer electrodes. Accordingly, it is expected to reduce battery size or expand battery electrode surface area. More preferably, it can use a carrier solution working as a solid electrolyte precursor to dispense with a solvent replacement step.

An electrode material deposited on the collector 4 is heated (at around 150 to 250° C.) or dissolved in a solvent (polar solvent, e.g., methanol, acetone or acetonitrile), to be molten, evaporated and solidified.

The materials useful for forming a solid electrolyte for the present invention include polyalkylene oxide, e.g., polyethylene oxide, polypropylene oxide or a copolymer thereof; polyalkylene carbonate, e.g., polyethylene carbonate, polypropylene carbonate, polytrimethylene carbonate or a copolymer thereof; and boric acid ester of the above compound. Moreover, a resin material can be also used so long as it can exhibit lithium ion conductivity when incorporated with a lithium salt, e.g., that of vinilidene polyfluoride, polyacrylonitrile or poly(meth)acrylic acid ester. The resin material may be incorporated with a low-molecular-weight compound as a plasticizer.

The low-molecular-weight compound to be incorporated in the resin material is typically a non-aqueous solvent which can dissolve an electrolytic salt or the resin material. The useful non-aqueous solvents include carboxylic acid ester, e.g., ethylene carbonate, propylene carbonate, butylene carbonate, dimethyl carbonate, diethyl carbonate or methylethyl carbonate; and ether, e.g., γ-butylolactone, tetrahydrofuran, ethylene glycol dimethyl ether, diethylene glycol dimethyl ether, triethylene glycol dimethyl ether, ethylene glycol methylethyl ether, ethylene glycol diethyl ether, diethylene glycol methylethyl ether, diethylene glycol diethyl ether, propylene glycol dimethyl ether or dipropylene glycol dimethyl ether. These non-aqueous solvents may be used either individually or in combination. Moreover, a known additive used for lithium-based secondary batteries, e.g., vinylene carbonate, may be also used.

Any electrolytic salt may be used for the electrolyte, so long as it is soluble in a gel electrolytic precursor composition and gel electrolyte. However, the following compounds are preferable: the compounds composed of a metallic cation and anion selected from the group consisting of the ions of chlorine, bromine, iodine, perchlorate, thiocyanate, tetrafluoroborate, hexafluorophosphate, trifluoromethanesulfonideimide, bispentafluoroethanesulfonideimide, stearylsulfonate, octylsulfonate, dodecylbenzenesulfonate, naphthalenesulfonate, dodecylnaphthalenesulfonate, 7,7,8,8-tetracyano-p-quinodimethane and lower aliphatic carboxylate. The metallic cations include Li ion. Concentration of the electrolytic salt is determined in consideration of ion conductivity which the gel electrolyte is required to have. It is normally 0.1 to 4.0 mol/kg, preferably 0.5 to 3.0 mol/kg.

The anode or cathode material commonly used has a particle size of 5 to 20 μm or more. However, the electrode material patterned to form the electrode by an electrophotographic process for the present invention preferably has a particle size of 0.1 to 10 μm or less, particularly preferably around 0.1 to 3 μm when a wet development method is employed. When a dry development method is employed, on the other hand, it is preferably around 3 μm or more in consideration of risks of pneumoconiosis or the like resulting from scattering of the particles. When it is below the above level, the electrode material should be handled in an environment having no effect on the human body, e.g., in an unmanned, closed space or in a mechanism which can completely prevent particle scattering.

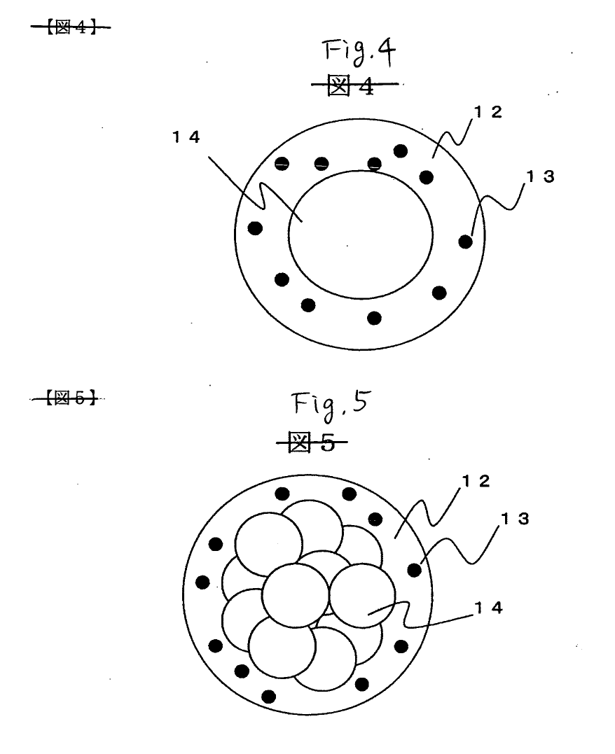

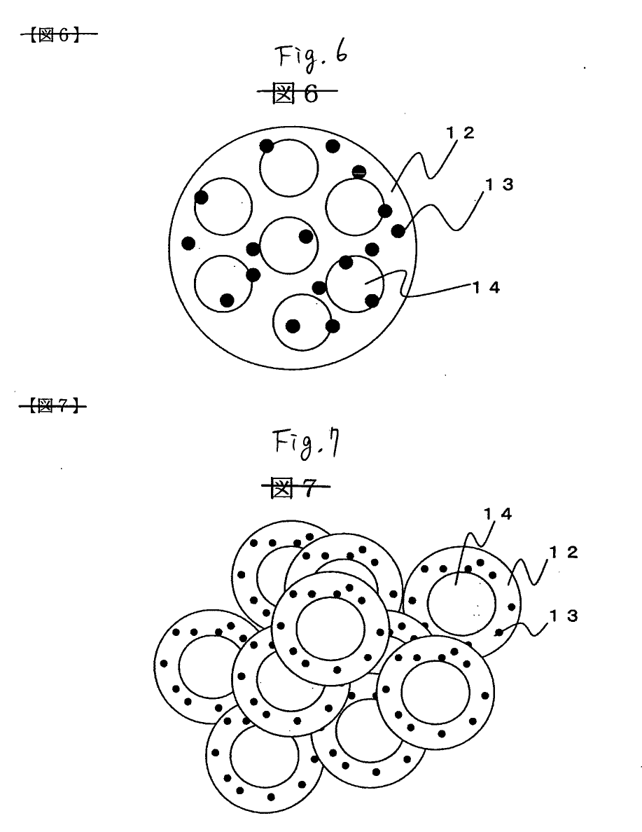

FIG. 4 illustrates an electrode material particle structure. Each particle of the anode or cathode material preferably has a structure with the electrode material 14 particle coated with the binder resin layer 12 incorporated with the electroconductive material particles 13 responsible for electroconductivity. The electrode material 14 particle shown in FIG. 4 is present in the form of single nucleus in the anode or cathode material. When it is difficult to incorporate the single nucleus to be coated with the binder resin layer 12, it may have another structure, e.g., a structure with a cluster in which the fine electrode material 14 particles agglomerate each other being incorporated in place of the single nucleus as illustrated in FIG. 5, or a structure with electrode material particles 14 and electroconductive material particles 13 incorporated in the binder resin layer 12 as illustrated in FIG. 6.

As described earlier, the anode or cathode material particle structure shown in FIG. 5 or 6 can reduce requirement of the binder resin 12 for the particle, and also can increase density of the electrode material 14 in the electrode material particle. Accordingly, it is effective for reducing cost and increasing energy density of the secondary battery in which it is used.

When it is difficult to keep well dispersed the anode or cathode material particles, each incorporated with the electrode material particle in the form of single nucleus (FIG. 4), the electrode material particles themselves may be clustered, where the cluster itself works as the electrode material particle, as shown in FIG. 7. The primary particle which constitutes the cluster is not limited to the electrode material particle shown in FIG. 4, but may be the one shown in FIG. 5 or 6. Moreover, the electrode material particle as the primary particle may be composed of a single material or clustered structure comprising 2 or more compositionally or structurally different primary particles.

The binder resin useful for the present invention may be selected from widely varying materials, including the above-described resin component used as a solid electrolyte. For example, the above-described other high-molecular-weight compounds include polyvinylidene fluoride (PVdF), hexafluoropropylene/acrylonitrile (PHFP/AN) copolymer, styrene/butadiene rubber (SBR), carboxymethyl cellulose (CMC), methyl cellulose (MC), ethyl cellulose (EC), polyvinyl alcohol (PVA), polyethylene oxide (PEO), polyethylene oxide/polypropylene oxide (PEO/PPO) copolymer, and one or more species of polymers of the above-described other polymerizable compound(s). Of these, polyethylene oxide, polyethylene oxide/polypropylene oxide copolymer, and polyalkylene glycol (meth)acrylate as a polymer of the above-described polymerizable compound are more preferable for their ion conductivity.

The patterned electrode preferably has as high an aspect ratio as possible to have an increased electrode area. A high aspect ratio can be realized by repeating cycles of patterning with electrode materials in the first stage, filling the gap between the anode and cathode with a solid electrolyte to a height of the patterned electrode materials, and patterning again the upper surfaces of the patterned electrode materials, to produce the battery electrodes of desired height. The aspect ratio is preferably 10 or more.

The patterned electrode material can be fixed by melting the binder resin under heating and solidifying it under cooling. The fixing temperature is preferably as low as possible. Another fixing method comprises temporarily dissolving a binder resin in a solvent and then evaporating the solvent to solidify the resin.

The secondary battery of the present invention is preferably used in the form of laminate composed of individual battery units, where laminate shape is not limited. Embedding the sheet-shaped secondary battery unit in a substrate, e.g., printed electronic circuit substrate, is another preferable method of using the present invention.

Purposes of the secondary battery of the present invention are not limited. It may go into various areas, e.g., IC cards, personal computers, large-size electronic computers, laptop personal computers, stylus-operated personal computers, laptop word processors, cellular phones, portable cards, watches, cameras, electronic shavers, cordless phones, facsimiles, videos, video cameras, electronic diaries, desktop calculators, electronic diaries having a communication function, portable copiers, liquid-crystal TV sets, electrically driven tools, cleaners, games having a function, e.g., virtual reality, toys, electrically driven bicycles, walking aids, wheel chairs and movable beds for healthcare purposes, escalators, elevators, fork lifts, golf carts, emergency power sources, load conditioners, power sources for power storage systems. Its applicable areas are not limited to consumer goods, but to military and space purposes.

The present invention is described in more detail by EXAMPLE, which by no means limits the present invention.

First, 100 mL of acetonitrile of special grade (Wako Pure Chemical Industries) was incorporated with 1.0 g of lithium cobaltate (Nippon Chemical Industrial, CELLSEED®) for the anode or synthetic graphite (Nippon Graphite Industry, SP270) for the cathode, and further with 5 μmL of triethylamine (Wako Pure Chemical Industries). The mixture was irradiated with ultrasonic waves to suspend the particles for ten minutes. This sufficiently dispersed the electrophoretically migrating particles in an acetonitrile bath, and the suspension was used as an electrodeposition bath. Next, an assembly of 1 cm square working electrode in the inter digital form and stainless steel plate, set in parallel to an inter digital electrode at a distance of 900 μm in the vertical direction, was immersed in the electrodeposition bath, where the working electrode with 5 μm wide tines arranged at intervals of 3 μm was prepared beforehand on a substrate to work as an inter digital secondary battery collector, and the stainless steel plate worked as a counter electrode. Then, a voltage of 8 V was applied from a DC power source to the bath for 5 minutes, and the power source was switched off. It was found, after a copper foil was withdrawn from the bath, that a lithium cobaltate layer for the anode or a synthetic graphite layer for the cathode was neatly formed to a height of 20 μm or more on the inter digital electrode. The electrode assembly for the present invention, prepared above, had an electrode surface area for charging/discharging between the electrodes approximately twice as large as or larger than the one of the same volume (1 cm by 1 cm by 20 μm), shown in FIG. 2, for a conventional planar secondary battery. The secondary battery was produced by filling the gap between the anode and cathode patterns prepared above with a solution of polyethylene oxide and LiN(SO₂CF₃) dissolved in acetonitrile, removing the acetonitrile by evaporation to solidify the polyethylene oxide, and drying at about 150° C. for 12 hours under a vacuum to remove moisture.

It should be further understood by those skilled in the art that although the foregoing description has been made on embodiments of the invention, the invention is not limited thereto and various changes and modifications may be made without departing from the spirit of the invention and the scope of the appended claims.

1. A secondary battery comprising;
an anode (a positive electrode) comprising an anode (a positive electrode) material and including an anode (a positive electrode) collector reversibly occluding and releasing an ion-conducting substance;
a cathode (a negative electrode) comprising a cathode (negative electrode) material and including a cathode (a negative electrode) collector; and
an electrolyte responsible for conducting an ion-conducting substance, wherein
the anode collector and the cathode collector are arranged alternately on one side of a substrate, the anode comprising the anode material is formed on the anode collector, the cathode comprising the cathode material is formed on the cathode collector, and a solid electrolyte is placed between the anode collector/the anode and the cathode collector/the cathode.

2. The secondary battery according to claim 1, wherein
the anode and the cathode are arranged in the form of inter digital in a top plan view, with each digital being oppositely arranged at a prescribed interval.

3. The secondary battery according to claim 1, wherein
the solid electrolyte is formed by filling a gap between the anode and the cathode with a liquid precursor for the electrolyte and then solidifying the precursor.

4. The secondary battery according to claim 1, wherein
the electrode material to be formed into the electrode is composed of particles having an average diameter of 0.1 to 10 μm.

5. The secondary battery according to claim 4, wherein
the electrode material has a binder resin layer on a surface thereof and an electroconductive material is dispersed in the binder resin layer.

6. The secondary battery according to claim 4, wherein
the electrode material particles are present in the form of not single nucleus but a cluster.

7. The secondary battery according to claim 4, wherein
the electrode material particles and the electroconductive material are incorporated in the binder resin.

8. A method for producing a secondary battery, comprising steps of:
forming an anode collector and a cathode collector alternately on one side of a substrate;
laminating an anode material on the anode collector;
laminating a cathode material on the cathode collector; and
placing a solid electrolyte between the anode collector/the anode and the cathode collector/the cathode, wherein
the anode material and the cathode material are charged by friction, each material is laminated due to a Coulomb force by applying a voltage to the anode collector and the cathode collector, and then the anode and the cathode are formed by melting the materials under heating or by a solvent.

9. The method according to claim 8, which is based on a dry process using no carrier solvent for a development.

10. The method according to claim 8,
which is based on a wet process using a carrier solvent for a development.

11. The method according to claim 8, wherein
a solid electrolyte is filled between the adjacent anode and cathode after forming the anode and the cathode.
